(19) United States
(12) Patent Application Publication
(10) Pub. No.: US 2022/0231981 A1
(43) Pub. Date: Jul. 21, 2022

(54) NOTIFICATION OUPUT TIMING BASED ON WEIGHTED IMPORTANCE SCORES

(71) Applicant: Hewlett-Packard Development Company, L.P., Spring, TX (US)

(72) Inventor: Arjun Angur Patel, San Diego, CA (US)

(73) Assignee: Hewlett-Packard Development Company, L.P., Spring, TX (US)

(21) Appl. No.: 17/615,216

(22) PCT Filed: Sep. 18, 2019
(86) PCT No.: PCT/US2019/051778

§ 371 Date: Nov. 30, 2021

(51) Int. Cl. H04L 51/226; G06Q 10/10; H04L 51/52

(52) U.S. Cl. CPC H04L 51/226; H04L 51/52; G06Q 10/107

(57) ABSTRACT

According to examples, an apparatus may include a processor and a memory on which may be stored instruction that when executed by the processor, may cause the processor to receive notification of a first type and determine whether other notifications of the first type were previously received. In some examples, a local importance score and a global importance score may be accessed, and based on wether other notifications of the first type were previously received, a weighted local importance score, a weighted global importance score, or both may be determined. In some examples, a weighted importance score may be determined based on the local importance score or the weighted local importance score and the global importance score or the weighted global importance score. In some examples, a timing at which the notification is output may be determined based on whether the weighted importance score is greater than a threshold value.

### BACKGROUND

Electronic devices, such as computing devices, may generate notifications. In some examples, applications running on the electronic devices may generate various types of notifications, for example, in response to receipt of an incoming electronic email message. As the number of applications and functions of the electronic devices increase, the number of notifications may also increase.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may determine a weighted importance score for a notification and may determine a timing at which the notification is output based on the weighted importance score;

FIG. 2 shows a block diagram of an example system in which the example apparatus depicted in FIG. 1 may be implemented;

FIG. 3 shows a flow diagram of an example method for determining a weighted importance score for a notification and determining a timing at which the notification is to be output based on the determined weighted importance score; and

FIG. 4 shows a block diagram of a non-transitory computer readable medium that may have stored thereon machine readable instructions for determining a weighted importance score for a notification and determining a timing at which the notification is to be output based on the determined weighted importance score.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Electronic devices, such as mobile phones, tablets, computers, or the like, may generate various types of notifications. As the number of applications executing on the electronic devices increase, so do the number of notifications. The increasing number of notifications may be distracting and disruptive to the user, and may reduce productivity of the user. The output of the notifications may also consume computing and memory resources of the electronic devices.

Different notifications may have differing levels of importance to a particular user. According to examples of the present disclosure, notifications may be outputted, e.g., provided to the user, at various times based on the importance (which may similarly be recited as an importance level) of the notification to the user. For example, email notifications from a co-worker may be considered to have a higher level of importance and such types of notifications may be delivered immediately, while notifications for spam emails may have a lower level of importance and thus may be ignored or delivered at a later time. In some examples, notifications for work-related emails may be considered to have a higher level of importance during work hours and may be considered to have a lower level of importance during after-work hours. Furthermore, a notification that may be important to one user may not be important to another user.

Disclosed herein are apparatuses, methods, and computer readable mediums for controlling delivery of notifications from applications at appropriate times (e.g., immediate delivery, deferred, or discarded). In some examples, machine learning algorithms or other appropriate types of processes may be used to learn the importance of different types of notifications, e.g., for a given user. In some examples, a machine learning algorithm may be used to learn an importance of a particular type of notification for a particular user. By way of example, a local machine learning algorithm may be used for learning an importance of a particular notification based on a local user's interactions with the particular notification. Additionally or alternatively, a global machine learning algorithm may be used for learning the importance of a particular type of notification to users globally, e.g., for a plurality of users at a larger scale than a local scale. A local importance score and a global importance score for a notification may be generated using the local machine learning algorithm and the global machine learning algorithm, respectively.

The use of both the local importance score and the global importance score may provide a benefit from both the local and global machine learning algorithms. However, in certain situations, the local importance score may be more representative of the user's preferences, while in other situations the global importance score may be more representative of the user's preferences. For example, the local importance score may be less accurate when the local system has no record of previously outputting a particular type of notification. In another example, the global importance score may not accurately represent the user's preferences since the global importance to score may be generic to multiple users and may not be customized for the local user. As such, in some examples, the local importance score and the global importance score may respectively be weighted based on a user's previous interaction with a particular type of notification, which may improve the accuracy of the predicted importance of a given notification.

In some examples, a processor may apply a weighting value to weight the importance scores from both the local machine learning algorithm and the global machine learning algorithm to improve accuracy of the resulting importance score. By way of example, when a local system has no record of previously outputting a particular notification, the global importance score may be used and the influence of the local importance score may be reduced or eliminated. In another example, when a local user has previously received a particular notification but less than a predetermined number of times, the global importance score and the local importance score may both be weighted based on a number of times that this particular type of notification was previously received. In some examples, when the local user has received the particular notification the predetermined number of times or more, this may indicate a high level of confidence of the user's preference, and thus the local importance score may be weighted higher or used exclusively while the influence of the global importance score may be reduced or eliminated in determining when to output the notification.

In some examples, a number of times that a local user received a particular notification may be tracked and the weighting values may be adjusted based on this number. In some examples, a user's actions in response to a recommendation included in an outputted notification may be tracked, and the weighting values may be adjusted based on whether or not the user followed the recommendation.

Through implementation of the features of the present disclosure, unwanted or less important notifications may be reduced or eliminated, which may result in fewer computations than are necessary, for example, to display a notification and process user interactions with the displayed notification. Furthermore, a reduced number of notifications may result in reduced energy consumption, for example, by deferring display of notifications to periods when energy costs may be lower or by automatically deleting the notifications to eliminate display of the notifications.

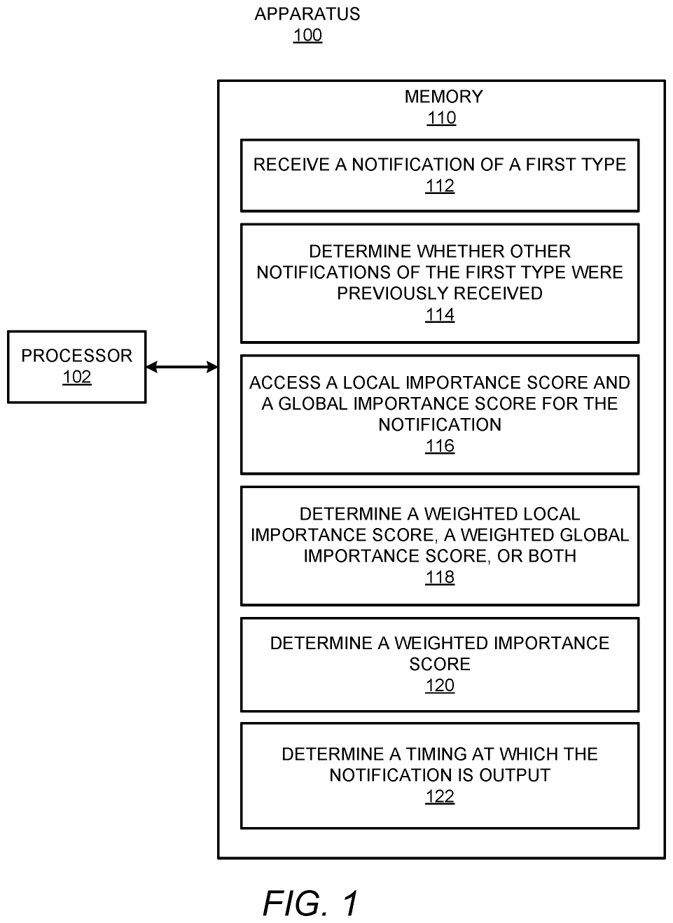

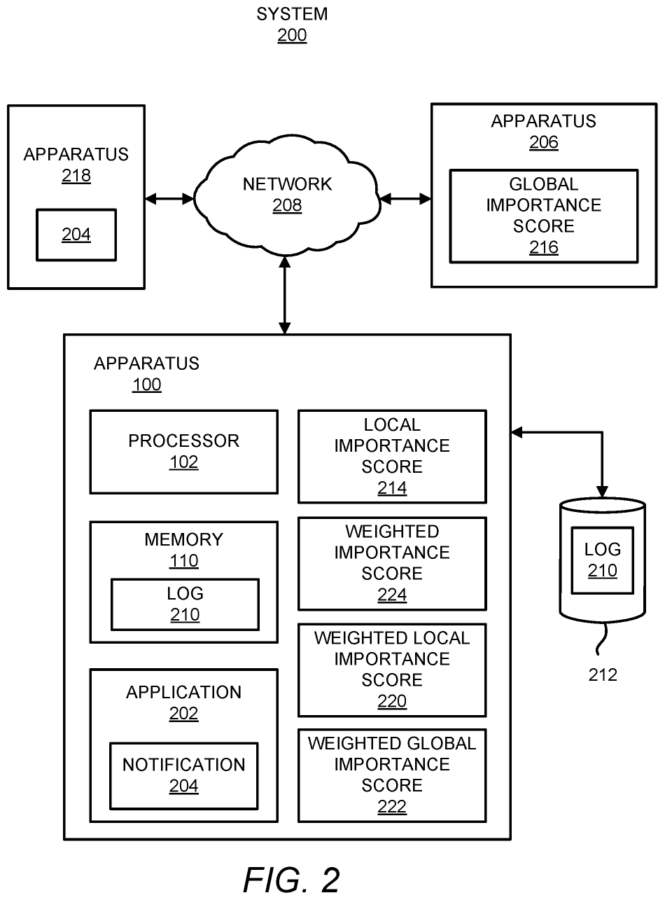

Reference is made to FIGS. 1 and 2. FIG. 1 shows a block diagram of an example apparatus 100 that may determine a weighted importance score for a notification and may determine a timing at which the notification is output based on the weighted importance score. FIG. 2 shows a block diagram of an example system 200 in which the example apparatus 100 depicted in FIG. 1 may be implemented. It should be understood that the example apparatus 100 depicted in FIG. 1 and the example system 200 depicted in FIG. 2 may include additional features and that some of the features described herein may be removed and/or modified without departing from the scopes of the apparatus 100 and/or the system 200.

The apparatus 100 may be a server, a node in a network (such as a data center), a personal computer, a laptop computer, a tablet computer, a smartphone, a network gateway, a network router, an electronic device such as Internet of Things (IoT) device, a robotic device, and/or the like. As shown, the apparatus 100 may include a processor 102 and a non-transitory computer readable medium, e.g., a memory 110. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100. In this regard, references to a single processor 102 as well as to a single memory 110 may be understood to additionally or alternatively pertain to multiple processors 102 and/or multiple memories 110.

The memory 110 may be an electronic, magnetic, optical, or other physical storage device that contains or stores executable instructions. The memory 110 may be, for example, Read Only Memory (ROM), flash memory, solid state drive, Random Access memory (RAM), an Electrically Erasable Programmable Read-Only Memory (EEPROM), a storage device, an optical disc, or the like. The memory 110 may be a non-transitory computer readable medium. The term “non-transitory” does not encompass transitory propagating signals.

As shown in FIG. 1, the processor 102 may execute instructions 112-122 to determine a weighted importance score for a particular notification 204. The instructions 112-122 may be machine readable instructions, e.g., non-transitory computer readable instructions. In other examples, the apparatus 100 may include hardware logic blocks or a combination of instructions and hardware logic blocks to implement or execute functions corresponding to the instructions 112-122.

The processor 102 may fetch, decode, and execute the instructions 112 to receive a notification 204 of a first type from an application 202. The application 202 may be an application program executing on the apparatus 100. In some examples, the application 202 may be an email program, conferencing program, gaming program, social networking program, or the like. In other examples, the application 202 may be an operating system (OS) of the apparatus 100 and the OS may generate the notification 204. In some examples, the notification 204 may be generated in an application 202 on a different apparatus 206, 218 and the apparatus 100 may receive the notification 204 over the network 208.

The notification 204 may be a particular type of notification and/or may have various characteristics that may define the type of notification 204. In some examples, a type of a notification 204 may be based on the source application 202, such as an email application, gaming application, conferencing application, or the like. The type of the notification 204 may also be based on other characteristics of the notification or the application, for example, a title of a message, name of the application 202, content of the notification 204, time of day, name of the sender, or the like.

The processor 102 may fetch, decode, and execute the instructions 114 to determine whether other notifications 204 of the first type were previously received. In some examples, the information on previous notifications 204 may be stored in a log 210 in a database 212. The information on previous notifications 204 and/or the log 210 may also or alternatively be stored in the memory 110. By way of example, the log 210 may store information on previous notifications 204 including the type of notification, a number of times a particular user has received a particular type of notification, and other appropriate types of information associated with the notifications 204.

The processor 102 may fetch, decode, and execute the instructions 116 to access a local importance score 214 and a global importance score 216 for the notification 204. In some examples, the processor 102 of apparatus 100 may generate the local importance score 214 for each notification 204 using a local machine learning algorithm, or another appropriate process. By way of particular example, the local machine learning algorithm may take multiple features of a notification 204 as inputs, which may include one or a combination of a title, an application name, contents of the notification, a sender, a time of day, or the like. The local machine learning algorithm may generate an output based on the inputs associated with a particular type of notification. By way of particular example, the output from the local machine learning algorithm may be a local importance score 214 associated with a particular notification 204. The local importance score 214 may have a value on a predetermined scale, for example, a number within a predefined range. For instance, a higher value may correspond to a higher importance level.

In some examples, the local machine learning algorithm may be trained based on a predetermined set of notifications. In addition, as additional notifications 204 are processed, the local machine learning algorithm may be trained based on the characteristics of these additional notifications 204 as well as the user's interaction with these notifications 204. In some examples, an open rate and/or a bounce back rate of a notification 204 may be used to train the local machine learning algorithm.

The open rate may be defined as a rate at which a user opens a particular type of notification 204. The bounce back rate may be defined as a rate at which the user exits out of the notification 204 after the notification 204 is opened. In some examples, by using the open rate and the bounce back rate associated with a particular notification 204, the local machine learning algorithm may be trained based on how often a user opens a particular type of notification 204 as well as the amount and type of interaction the user has with the notification 204.

In some examples, an emotional feedback associated with a notification 204 may be used to train the local machine learning algorithm. The processor 102 may determine the emotional feedback based on a captured image of the user and facial recognition of the user. The user's emotional response to a particular notification 204 may be used to train the local machine learning model. In some examples, the sensed facial recognition information may be detected through a camera disposed on a robotic device. In some examples, the robotic device may physically move to a particular user to deliver notifications 204, for instance, based on determined importances of the notifications 204.

In some examples, the global importance score 216 may be generated in an apparatus 206 on the network 208. By way of particular example, the apparatus 206 may be a server connected to the network 208 and may collect information regarding notifications 204 from multiple apparatuses 218 on the network 208. In some examples, a global machine learning algorithm on the apparatus 206 may generate the global importance score 216 and the processor 102 of apparatus 100 may access the global importance score 216. The global importance score 216 may be an importance score generated based on interaction with particular types of notifications 204 by all users or a group of the users at multiple apparatuses 218 on the network 208.

In some examples, the global system, or apparatus 206, may categorize past notification interactions based on a persona of the requesting system, e.g., the apparatus 100. The apparatus 206 may identify the persona of the apparatus 100 in order to determine the global importance score. For example, the apparatus 206 may include a separate model for multiple personas, such as a gamer, a student, a business owner, or the like as each user of the multiple personas may interact with notifications in a different manner. For example, a gamer may be more interested in game promotion notifications to be delivered immediately, whereas a business owner may be more interested in business relevant emails being delivered immediately.

In some examples, the apparatus 206 may define personas based on a clustering algorithm, or the like. The apparatus 206 may first track all of the notifications that the user of the local apparatus 100 has previously received and how that user interacted with each of the notifications. Based on the tracked information, the apparatus 206 may place the user in a particular personal of multiple persona buckets, where each persona in the multiple personal buckets may have a separate global model.

In some examples, the global machine learning algorithm may take multiple features of a notification 204 as inputs. The inputs may include one or a combination of a title, an application name, contents of the notification, the sender, a time of day, or the like. The global machine learning algorithm may generate an output based on the inputs associated with a particular type of notification. By way of particular example, the output may be a global importance score 216 associated with a particular notification 204. The global importance score 216 may have a value on a predetermined scale, for example, the global importance score 216 may be a number within a predefined range. The global importance score 216 and the local importance score 214 may have the same scale.

The global machine learning algorithm may be trained based on a predetermined training set of notifications. In some examples, as additional notifications 204 are processed, the global machine learning algorithm may be continued to be trained based on characteristics of these notifications 204 as well as multiple users' interactions with these notifications 204. In some examples, an open rate and/or a bounce back rate of the notifications 204 may be used to train the global machine learning algorithm. In some examples, by using the open rate and the bounce back rate associated with a particular notification 204, the global machine learning algorithm may be trained based on how often the users as a group open a particular type of notification 204 as well as the amount and type of interactions the users have with the notification 204.

In some examples, emotional feedbacks of users associated with a particular type of notification 204 may be used to train the global machine learning algorithm. The processor 102 may determine the emotional feedbacks of the users responsive to the notifications using facial recognition technology on the users. The emotional responses of a group of users to a particular notification 204 may be used to train the local machine learning model about that notification 204. In some examples, the sensed facial recognition information may be detected through a camera disposed on a robotic device. In some examples, the robotic device may physically move to a particular user to deliver notifications 204 based on determined importance of the notifications 204.

In some examples, the global importance score 216 for a plurality of different types of notifications 204 may be stored in the apparatus 206. A plurality of global importance scores 216 may be stored in a log on the apparatus 206. In some examples, the global importance scores 216 for known types of notifications may be retrieved and stored locally on the apparatus 100. By way of particular example, a plurality of global importance scores 216 may be stored in the log 210 in the memory 110 and/or the database 212.

The processor 102 may fetch, decode, and execute the instructions 118 to determine a weighted local importance score 220, a weighted global importance score 222, or both, based on a determination of whether other notifications 204 of the first type were previously received. By way of particular example, the processor 102 may determine whether a particular type of notification 204 was previously received at the apparatus 100. The processor 102 may access the log 210 in the database 212 to determine whether and a number of times that the particular type of notification 204 was received at the apparatus 100. As discussed herein, the weighted local importance score 220 and/or the weighted global importance score 222 may be determined based on whether or a number of times that the particular type of notification 204 was received at the apparatus 100.

The processor 102 may fetch, decode, and execute the instructions 120 to determine the weighted importance score 224 based on the local importance score 214 or the weighted local importance score 220 and the global importance score 216 or the weighted global importance score 222. The processor 102 may use one or a combination of the importance scores. In some examples, based on a determination that other notifications of the first type were never previously received at the apparatus 100, the processor 102 may fully weight the global importance score 216 while minimizing the weight of the local importance score 214. When a particular type of notification 204 is new (e.g., not previously seen), the local importance score 214 may not be able to accurately predict the user's preference for this particular type of notification 204. Therefore, the global importance score 216 may be more heavily relied upon, while minimizing or eliminating the impact of the local importance score 214 on the weighted importance score 224. In some examples, the processor 102 may determine the weighted importance score 224 to be equal to the weighted global importance score 222, thereby eliminating the influence of the weighted local importance score 220.

In some examples, based on a determination that other notifications 204 of the first type were previously received at the apparatus 100 a threshold number of times or more, the processor 102 may fully weight the local importance score 214 while minimizing the weight of the global importance score 216. For example, when notifications 204 of a particular type are received multiple times (e.g., the threshold number of times or more), the local importance score 214 may more accurately reflect the user's preferences for this particular type of notification than may the global importance score 216. Therefore, when a particular type of notification 204 is determined to have been received a threshold number of times or more, the local importance score 214 may be heavily relied upon, while minimizing the impact of the global importance score 216 on the weighted importance score 224. In some examples, the processor 102 may determine the weighted importance score 224 to be equal to the weighted local importance score 220, thereby eliminating the influence of the weighted global importance score 222.

In some examples, based on a determination that other notifications of the first type were previously received but less than the threshold number of times or more, the processor 102 may determine the weighted importance score 224 based on both of the weighted local importance score 220 and the weighted global importance score 222.

In some examples, the processor 102 may determine the weighted importance score 224 based on a weighting variable λ. The weighting variable λ may be based on a number of times in which the other notifications 204 of the first type were previously received. The weighting variable λ may be calculated based on Equation 1:

$$λ = \frac{\# Seen Locally}{Notification Threshold} \qquad Equation 1$$

Based on the weighting variable, the processor 102 may determine the weighted importance score 224 based on Equation 2:

$$\begin{matrix}{W}_{FINAL} = ( {( λ )}^{⋆} {S}_{L O C A L} ) + ( ( 1 - λ ) ⋆ {S}_{GLOBAL} ) \\ & Equation 2 \\ {W}_{FINAL} = {W}_{LOCAL} + {W}_{GLOBAL} & Equation 3\end{matrix}$$

where S_{LOCAL} may represent the local importance score 214, S_{GLOBAL} may represent the global importance score 216, the weighting variable λ may represent a local weighting value (λ), (1−λ) may represent a global weighting value, W_{LOCAL} may represent the weighted local importance score 220, W_{GLOBAL} may represent the weighted global importance score 222, and W_{FINAL} may represent the weighted importance score 224.

In some examples, the processor 102 may determine the weighting variable λ based on the number of times in which the other notifications of the first type were previously received, and may determine the weighted local importance score W_{LOCAL}, the weighted global importance score W_{GLOBAL}, or both, based on the determined weighting variable λ. Referring to Equation 2, if a particular type of notification has never been received, λ=0 and thus the weighted importance score 224 (W_{FINAL}) may equal the local importance score 214 (S_{LOCAL}). In some examples, when the particular type of notification is determined to have been previously received a threshold number of times or more, the number of times previously received locally may be set to the threshold number of times, e.g., λ=1. The weighted importance score 224 may thus be equal to the global importance score 216 (S_{GLOBAL}).

The processor 102 may determine a local weighting value (λ) and a global weighting value (1−λ) based on the determined weighting variable λ. In some examples, a sum of the local weighting value (λ) and the global weighting value (1−λ) may be equal to one. The processor 102 may determine the weighted local importance score W_{LOCAL} by weighting the local importance score S_{LOCAL} using the local weighting value (λ). The processor 102 may determine the weighted global importance score W_{GLOBAL} by weighting the global importance score S_{GLOBAL} using the global weighting value (1−λ).

In some examples, the processor 102 may track user interactions with the notification 204 based on a recommendation in an output notification. The recommendation in an output notification may indicate that the notification 204 is for a spam message and may recommend the user to delete the notification, may indicate that the notification is related to an important message and may recommend the user to immediately view the notification, or the like. In some examples, the processor 102 may modify the weighting variable λ based on the tracked user interactions. By way of particular example, when the recommendation is to immediately open the notification/message, but the processor 102 detects the user quickly deleting the notification, the processor 102 may determine that the recommendation was not accurate. In this case, the processor 102 modify the weighting variable λ, e.g., to reduce its value.

In some examples, the weighting variable λ may be increased in value when a recommendation associated with a notification 204 is determined to be accurate, and the weighting variable λ may be reduced in value when a recommendation associated with a notification 204 is determined to be inaccurate. In some examples, in order to modify the value of the weighting variable λ, a value of the threshold number of times received as shown in Equation 1 may be increased or decreased by a predefined adjustment value.

In some examples, the weighting variable λ may be referred to as a local weighting variable. The local weighting variable λ may be a number in the range of 0 to 1. By way of particular example, the local weighting variable λ may initially be set to a value of 0, and may be incremented or decremented by a predefined adjustment value (e.g., 0.01) based on whether the user follows the recommendation associated with the output notification. In this manner, the accuracy of the local weighting variable λ may be improved to more accurately reflect a particular user's preferences each time a notification 204 of a particular type is processed.

The processor 102 may fetch, decode, and execute the instructions 122 to determine a timing at which the notification 204 may be output. In some examples, the processor 102 may, based on a determination that the determined weighted importance score W_{FINAL} is greater than or equal to a threshold value, immediately output the notification. In some examples, the processor 102 may, based on a determination that the determined weighted importance score W_{FINAL} is less than the threshold value, a delay output of the notification until predetermined time. By way of particular example, when the weighted importance score W_{FINAL} is less than the threshold value, the processor 102 may defer output of the notification 204 to after-work hours, to time periods during which utility costs (e.g., data or energy) are lower, and/or the like. In some examples, the weighted importance score W_{FINAL} may be a number within a predetermined range (e.g., 1 to 100) or a value within a predefined set of levels (e.g., low, medium, high), and the threshold value may be set to be a number within the predetermined range (e.g., 75) or a level within the predefined set of levels (e.g., high). By way of example, a level within the predefined set of levels may include a range of the numbers that may be assigned to the particular level. In some examples, the threshold value may be set by a user, set automatically based on user interactions with output notifications 204, or both.

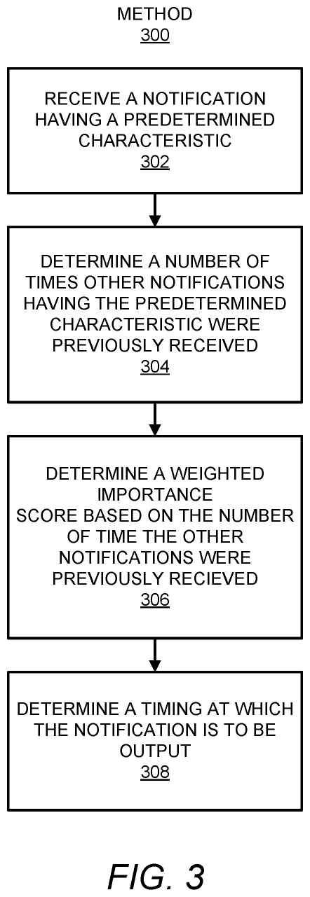

Turning now to FIG. 3, there is shown a flow diagram of an example method 300 for determining a weighted importance score W_{FINAL} for a notification 204 and determining a timing at which the notification 204 is to be output based on the determined weighted importance score W_{FINAL}. It should be understood that the method 300 depicted in FIG. 3 may include additional operations and that some of the operations described therein may be removed and/or modified without departing from the scope of the method 300. The description of the method 300 is also made with reference to the features depicted in FIGS. 1-2 for purposes of illustration. Particularly, the processor 102 of the apparatus 100 may execute some or all of the operations included in the method 300.

At block 302, the processor 102 may receive a notification 204 having a predetermined characteristic. The notification 204 may be received from an application 202 on the apparatus 100 or from a device over the network 208. The predetermined characteristic of the notification 204 may indicate a type of the notification 204, which may include one or a combination of a title of a message, name of the application 202, content of the notification 204, time of day, name of the sender, and/or the like.

At block 304, the processor 102 may determine a number of times other notifications having the predetermined characteristic were previously received. Information related to the other previous notifications 204 may be stored in a log 210 in a database 212 or locally in a memory 110. In some examples, the processor 102 may perform a lookup in the log 210 based on multiple ones of the predetermined characteristics of the notification 204, such as name of application, the sender, the time of day, and/or the like. The determined number of times may reflect the number of times that the particular notification 204 having each of the multiple ones of the predetermined characteristics were previously received at the apparatus 100.

At block 306, the processor 102 may determine a weighted importance score W_{FINAL} for the notification 204. In some examples, the processor 102 may determine the weighted importance score W_{FINAL} based on a first weighting applied to a local importance score S_{LOCAL} and a second weighting applied to a global importance score S_{GLOBAL} for the notification 204. In some examples, the first weighting and the second weighting may be based on the number of times that other notifications 204 having the predetermined characteristic were previously received. In some examples, the first weighting may be the local weighting value (λ) and the second weighting may be the global weighting value (1−λ), as previously described with reference to FIGS. 1 and 2.

In some examples, the processor 102 may determine the first weighting based on a ratio of the number of times in which other notifications having the predetermined characteristic were previously received to a predetermined threshold number of times.

In some examples, based on a determination that other notifications 204 having the predetermined characteristic were not previously received, the processor 102 may determine the weighted importance score W_{FINAL} to equal the global importance score S_{GLOBAL}. In some examples, based on a determination that other notifications of having the predetermined characteristic were previously received the predetermined threshold number of times or more, the processor 102 may determine the weighted importance score W_{FINAL} to equal the local importance score S_{LOCAL}.

In some examples, based on a determination that other notifications having the predetermined characteristic were previously received but less than the predetermined threshold number of times, the processor 102 may determine the weighted importance score W_{FINAL} based on a sum of a weighted local importance score W_{LOCAL} and a weighted global importance score W_{GLOBAL}.

In some examples, based on a determination that the weighted importance score is greater than or equal to a threshold value, the processor 102 may immediately output the notification 204, and based on a determination that the weighted importance score W_{FINAL} is less than the threshold value, the processor 102 may delay output of the notification until a predetermined time. In some examples, the weighted importance score W_{FINAL} may be represented by a number in a predefined range, a predefined level, or the like. When a particular notification 204 is determined to have a weighted importance score W_{FINAL} above the threshold value within the predefined range indicating that the notification 204 is important, the processor 102 may immediately output the notification 204. However, when the weighted importance score W_{FINAL} is below the threshold value indicating that the notification 204 may be less important, the processor 102 may defer output of the notification 204 to a later time, such as to after-work hours, or the like.

Some or all of the operations set forth in the method 300 may be included as utilities, programs, or subprograms, in any desired computer accessible medium. In addition, the method 300 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

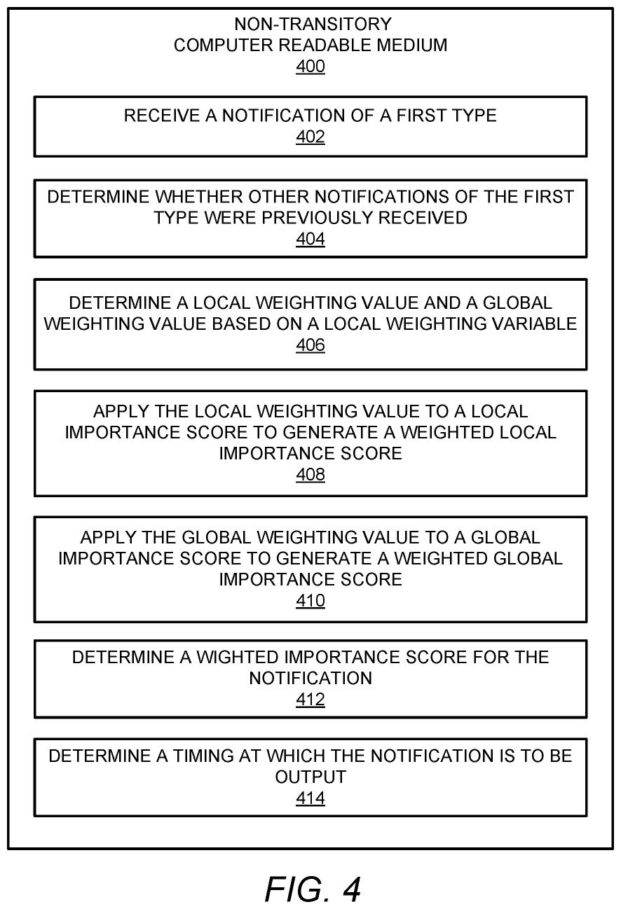

Turning now to FIG. 4, there is shown a block diagram of a non-transitory computer readable medium 400 that may have stored thereon machine readable instructions for determining a weighted importance score W_{FINAL} for a notification 204 and determining a timing at which the notification 204 is to be output based on the determined weighted importance score W_{FINAL}. It should be understood that the computer readable medium 400 depicted in FIG. 4 may include additional instructions and that some of the instructions described herein may be removed and/or modified without departing from the scope of the computer readable medium 400 disclosed herein. The computer readable medium 400 may be a non-transitory computer readable medium. The term “non-transitory” does not encompass transitory propagating signals. The description of the non-transitory computer readable medium 400 is also made with reference to the features depicted in FIGS. 1-2 for purposes of illustration. Particularly, the processor 102 of the apparatus 100 may execute some or all of the instructions 402-414 included in the non-transitory computer readable medium 400.

The computer readable medium 400 may have stored thereon machine readable instructions 402-414 that a processor, such as the processor 102 depicted in FIGS. 1 and 2, may execute. Particularly, the processor 102 may execute instructions 402 to receive a notification 204 of a first type. In some examples, the processor 102 may receive the notification 204 from an application 202. The type associated with the notification 204 may be based on a title of a message, name of the application 202, content of the notification 204, time of day, name of the sender, and/or the like.

The processor 102 may execute the instructions 404 to determine whether other notifications 204 of the first type were previously received. In some examples, the processor 102 may retrieve information related to other notifications 204 from a log 210 in a database 212 or in a memory 110.

The processor 102 may execute the instructions 406 to determine a local weighting value (λ) and a global weighting value (1−λ) based on a local weighting variable λ. In some examples, the local weighting variable λ may be based on a determination of whether other notifications 204 of the first type were previously received and user interactions with output notifications 204. By way of example, the local weighting variable λ may be a number within a prescribed range (e.g. between 0 and 1) that may be varied based on a user's interaction with a notification 204 of a particular type.

The processor 102 may execute the instructions 408 to apply the local weighting value (λ) to a local importance score S_{LOCAL} to generate a weighted local importance score, and additionally or alternative., the processor 102 execute instructions 410 to apply the global weighting value W_{GLOBAL} to a global importance score S_{GLOBAL} to generate a weighted global importance score W_{LOCAL}. In some examples, the local importance score S_{LOCAL} may be generated by a local machine learning algorithm and the global importance score S_{GLOBAL} may be generated by a global machine learning algorithm. In some examples, the local weighting value (λ) and the global weighting value (1−λ) may be based on the local weighting variable λ.

The processor 102 may execute the instructions 412 to determine a weighted importance score W_{FINAL} for the notification 204 based on the weighted local importance score W_{LOCAL} and the weighted global importance score W_{GLOBAL}. The processor 102 may execute instructions 414 to determine a timing at which the notification 204 is to be output based on the weighted importance score W_{FINAL} for the notification 204.

In some examples, the processor 102 may determine whether a user interaction with the notification 204 that is output corresponds with an action advised in the output notification 204. By way of example, based on a determination that the user interaction corresponds to the action advised in the output notification 204, the processor 102 may increase a value of the local weighting variable λ by a predefined adjustment value, and based on a determination that the user interaction does not correspond to the action advised in the output notification, decrease the value of the local weighting variable λ by the predefined adjustment value.

In some examples, the local weighting variable λ may have an initial value of 0, and the local weighting variable λ may be incremented or decremented by a predefined adjustment value of 0.01 each time a notification 204 of the first type is received based on a user's interaction with the notification 204. When the local weighting variable λ is 0 or near zero, the local importance score S_{LOCAL} may not influence the weighted importance score W_{FINAL} for the notification 204. Alternatively, when the local weighting variable λ is 1 or near 1, the local importance score S_{LOCAL} may more heavily influence the weighted importance score W_{FINAL} for the notification 204 while the global importance score S_{GLOBAL} may not influence the weighted importance score W_{FINAL}.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which are stored machine readable instructions that when executed by the processor, cause the processor to:
receive a notification of a first type;
determine whether other notifications of the first type were previously received;
access a local importance score and a global importance score for the notification;
based on a determination of whether other notifications of the first type were previously received, determine a weighted local importance score, a weighted global importance score, or both;
determine a weighted importance score based on the local importance score or the weighted local importance score and the global importance score or the weighted global importance score; and
determine a timing at which the notification is output based on whether the determined weighted importance score is greater than a threshold value.

2. The apparatus of claim 1, wherein the instructions are further to cause the processor to:
determine a weighting variable based on a number of times in which the other notifications of the first type were previously received, and
determine the weighted local importance score, the weighted global importance score, or both, based on the determined weighting variable.

3. The apparatus of claim 2, wherein the instructions are further to cause the processor to:
track user interactions with the notification based on a recommendation in an output notification; and
modify the weighting variable based on the tracked user interactions.

4. The apparatus of claim 2, wherein the instructions are further to cause the processor to:
determine the weighting variable based on a ratio of the number of times that the other notifications of the first type were previously received to a predetermined threshold number of times.

5. The apparatus of claim 4, wherein the instructions further to cause the processor to:
determine a local weighting value and a global weighting value based on the determined weighting variable, wherein a sum of the local weighting value and the global weighting value is equal to one;
determine the weighted local importance score by weighting the local importance score using the local weighting value; and
determine the weighted global importance score by weighting the global importance score using the global weighting value.

6. The apparatus of claim 5, wherein the instructions further to cause the processor to:
based on a determination that the notification of the first type was previously received but less than the predetermined threshold number of times, determine the weighted importance score based on a sum of the weighted local importance score and the weighted global importance score;
based on a determination that other notifications of the first type were not previously received, determine the weighted importance score to be the global importance score; and
based on a determination that other notifications of the first type were previously received the predetermined threshold number of times or more, determine the weighted importance score to be the local importance score.

7. The apparatus of claim 1, wherein the instructions further to cause the processor to:
based on a determination that the determined weighted importance score is greater than or equal to the threshold value, immediately output the notification; and
based on a determination that the determined weighted importance score is less than the threshold value, delay output of the notification until a predetermined time.

8. The apparatus of claim 1, wherein the instructions further to cause the processor to:
train a local machine learning algorithm that is to determine the local importance score based on an open rate of the notification, a bounce back rate in which the notification is closed after the notification is opened, or an emotional feedback associated with the notification.

9. A method comprising:
receiving, by a processor, a notification having a predetermined characteristic;
determining, by the processor, a number of times other notifications having the predetermined characteristic were previously received;
determining, by the processor, a weighted importance score for the notification, wherein the weighted importance score is based on a first weighting applied to a local importance score and a second weighting applied to a global importance score for the notification, and wherein the first weighting and the second weighting are based on the number of times that other notifications having the predetermined characteristic were previously received; and
determining, by the processor, a timing at which the notification is to be output based on the determined weighted importance score.

10. The method of claim 9, further comprising
determining the first weighting based on a ratio of the number of times other notifications having the predetermined characteristic were previously received to a predetermined threshold number of times.

11. The method of claim 10, further comprising:
based on a determination that other notifications having the predetermined characteristic were not previously received, determining the weighted importance score to equal the global importance score; and
based on a determination that other notifications of having the predetermined characteristic were previously received the predetermined threshold number of times or more, determining the weighted importance score to equal the local importance score.

12. The method of claim 10, further comprising:
based on a determination that other notifications having the predetermined characteristic were previously received but less than the predetermined threshold number of times, determining the weighted importance score based on a sum of a weighted local importance score and a weighted global importance score.

13. The method of claim 10, further comprising:
based on a determination that the weighted importance score is greater than or equal to a threshold value, immediately outputting the notification, and
based on a determination that the weighted importance score is less than the threshold value, delaying output of the notification until a predetermined time.

14. A non-transitory computer readable medium on which is stored machine readable instructions that, when executed by a processor, cause the processor to:
receive a notification of a first type;
determine whether other notifications of the first type were previously received;
determine a local weighting value and a global weighting value based on a local weighting variable, the local weighting variable being based on a determination of whether other notifications of the first type were previously received and user interactions with output notifications;
apply the local weighting value to a local importance score to generate a weighted local importance score;
apply the global weighting value to a global importance score to generate a weighted global importance score;
determine a weighted importance score for the notification based on the weighted local importance score and the weighted global importance score; and
determine a timing at which the notification is to be output based on the weighted importance score for the notification.

15. The computer readable medium of claim 14, wherein the processor is further to:
determine whether a user interaction with the notification that is output corresponds with an action advised in the output notification;
based on a determination that the user interaction corresponds to the action advised in the output notification, increase a value of the local weighting variable by a predefined adjustment value; and
based on a determination that the user interaction does not correspond to the action advised in the output notification, decrease the value of the local weighting variable by the predefined adjustment value.
